(19) United States
(12) Patent Application Publication
(10) Pub. No.: US 2007/0004554 A1
(43) Pub. Date: Jan. 4, 2007

(54) Method for operating a drive train of a motor vehicle

(75) Inventors: Dieter Hans, Waldenbuch (DE); Stefan Kanngiesser, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/563,579

(22) PCT Filed: Jun. 30, 2004
(86) PCT No.: PCT/EP04/07066

§ 371 Date: Jun. 5, 2006

(30) Foreign Application Priority Data
Jul. 8, 2003 (DE) 103 30 952.7

(51) Int. Cl. B60W 10/04

(52) U.S. Cl. 477/107

(57) ABSTRACT

1. Method for operating a drive train of a motor vehicle. 2.1. In motor vehicles having a power-shift automatic transmission, delayed reactions of the motor vehicle to shifting-down requests occur owing to reaction times in the activation of the automatic transmission. The object of the invention is to propose a method for operating a drive train which permits spontaneous feedback from the drive train to values predefined by the driver of the vehicle. 2.2 According to the invention, when a shifting-down request is detected a slip is increased at a clutch which is arranged between a drive motor and the automatic transmission. As a result, the rotational speed of the drive motor increases directly after the detection of the shifting-down request and a vehicle driver immediately receives feedback from the drive train. The motor vehicle thus provides a very spontaneous and dynamic impression. 2.3 Use in a motor vehicle.

### BACKGROUND AND SUMMARY OF THE INVENTION

The invention relates to a method for operating a drive train of a motor vehicle having a drive motor, a power-shift automatic transmission and a clutch which is activated by extraneous force.

Known motor vehicles have a drive motor, a power-shift automatic transmission in the form of an automatic multi-step reduction gearbox of a planetary design, and a hydrodynamic torque converter which is arranged between the drive motor and the multi-step reduction gear and has the converter lock-up clutch. In order to achieve a high efficiency of the drive train and thus a low fuel consumption, the converter lock-up clutch is closed directly after the vehicle has driven off and also remains closed during the entire driving operation provided that the velocity of the motor vehicle is not too low.

When the multi-step reduction gearbox is shifted, one hydraulically activated multi-disk clutch or brake is disconnected and another is connected. Before a multi-disk clutch or brake can transmit a torque, it must firstly be filled with gear oil—in a so-called filling phase which may take between 300 and 500 ms—before the pressure then builds up and torque can thus be transmitted.

If a control device of the multi-step reduction gearbox and of the converter lock-up clutch detects a shifting-down request, for example owing to the activation of an accelerator pedal by a driver of a vehicle, the multi-disk clutch which is to be connected is firstly filled in a filling phase. During this filling phase, the multi-disk clutch which is to be disconnected cannot yet be opened since otherwise there is the risk of an excessively large rise of the drive motor. As a result, the rotational speed of the drive motor does not begin to change until after the filling phase has ended. The start of the shifting-down process can therefore not be detected by the driver of the vehicle until after the filling phase has ended.

U.S. Pat. No. 4,526,557 A describes a method for operating a drive train of a motor vehicle having a continuously variable automatic transmission. A converter with converter lock-up clutch is arranged between the drive motor and the automatic transmission. As soon as it is detected that a rapid adjustment in the direction of a shorter transmission ratio is necessary, the converter lock-up clutch is completely opened. U.S. Pat. No. 5,842,949 A describes a method for operating a drive train of a motor vehicle having an automatic transmission of a planetary design. A converter with converter lock-up clutch is arranged between the drive motor and the automatic transmission. In the case of a shifting-down request, the converter lock-up clutch is completely opened. The opening speed is variable here. In the article “Geregelte Wandlerkupplung f\acute{ú}r den neuen 7er von BMW [Controlled converter clutch for the new BMW 7 series]” by Ferit K\acute{ú}c\acute{ú}kay and Christian Bock, published in ATZ Automobiltechnische Zeitschrift, Franck'sche Verlagshandlung Stuttgart, volumn 96 (1994) No. 11, pages 690-697, a method is described for actuating a controlled converter lock-up clutch of a converter which is arranged between a drive motor and an automatic transmission. A predefined slip is set at the converter lock-up clutch. In order to improve the shifting comfort, the slip is increased during a shifting process.

The object of the invention is accordingly to propose a method for operating a drive train which permits spontaneous feedback of the drive train to values predefined by the driver of the vehicle and a comfortable shifting-down process.

The drive train has a power-shift automatic transmission in which a transmission ratio can be changed by actuator elements, in particular hydraulic clutches and brakes. When the transmission ration changes, such as when there is a gearspeed change in the case of an automatic multi-step reduction gearbox, a drive connection between the drive motor and driven vehicle wheels is not interrupted. The change in the transmission ratio therefore occurs under load. The power-shift automatic transmission can therefore be embodied, for example, as an automatic multi-step reduction gearbox of a planetary design or cylindrical gear design, an infinitely variable transmission or a double clutch transmission.

Shifting-down is understood to be shifting in the direction of a shorter transmission ratio of the automatic transmission, such as shifting from the fourth gearspeed into the third gearspeed of a multi-step reduction gearbox. In the case of an infinitely variable transmission, shifting-down is understood to mean adjustment of the transmission ratio in the direction of a shorter transmission ratio. In the case of shifting-down the rotational speed at the input to the automatic transmission, and thus the rotational speed of the drive motor, are always larger after the shifting process than before the shifting process.

The clutch may be embodied, for example, as a converter lock-up clutch of a hydrodynamic converter or an automated starting clutch. The clutch can be activated by an electronic actuator element, such as an electric motor, or a hydraulic or pneumatic actuator element, such as a piston-cylinder unit, to be opened and closed. A defined slip at the clutch, that is to say a defined differential speed between the clutch input and clutch output, can be set by the control device.

By increasing the slip at the clutch, the rotational speed of the drive motor is adjusted in a monotonous and thus permanently increasing fashion to a target rotational speed after the shifting-down process has ended. In particular, the rotational speed of the drive motor can reach the target rotational speed just before the rotational speed at the input of the automatic transmission reaches the target rotational speed. The target rotational speed results from the speed of the motor vehicle after the shifting-down process has ended and the overall transmission ratio of the drive train is made up, for example, of the transmission ratio of the automatic transmission and of the rear axle gearbox. The drive motor must reach this target rotational speed after the shifting-down process has ended and the sip at the clutch has been eliminated. The monotonously increasing adjustment of the rotational speed to the target rotational speed can ensure a harmonic profile of the rotational speed of the drive motor during the shifting-down process. As a result, the shifting-down process takes place in a particularly comfortable fashion.

The method according to the invention can be used advantageously, in particular, in conjunction with automatic transmissions in which reaction times or dead times occur when the actuating elements are actuated. One possibility of a reaction time is the described filling phase of a multi-disk clutch. Reaction times or dead times occur in particular in the case of hydraulically activated automatic transmissions.

The shifting-down request may be detected by the control device itself or be triggered by a driver of a vehicle by an operator control element. The control device detects shifting-down requests in a known fashion from operational variables of the motor vehicle such as, the velocity, and values predefined by the driver of the vehicle such as the degree of activation of a power actuator.

In order to set a slip, the clutch is at least partially opened, as a result of which the transmissible torque of the clutch drops. The drive motor is thus relieved of loading and its rotational speed can rise quickly. The clutch and/or its mode of operation are defined in such a way that they can react very quickly to requests by the control device. As a result, the at least partial opening of the clutch and thus the setting of a slip can be carried out very quickly and without an appreciable time delay. The rotational speed of the drive motor thus rises directly after the detection of a shifting-down request, and the driver of the vehicle thus receives immediate and spontaneous feedback.

Direct feedback is important for the overall impression of a motor vehicle and thus for the satisfaction of the driver of the vehicle in particular if a shifting-down process is triggered by a sudden increase in a degree of activation of a power actuator, such as an accelerator pedal. The driver of the vehicle expects an increase in the rotational speed of the drive motor in reaction to the increase. The shorter the time period until the anticipated reaction occurs, the more spontaneous and energetic the impression of the motor vehicle's behavior. When the method according to the invention is used, this time period is very short, as a result of which the motor vehicle is thought to be very spontaneous.

The method according to the invention has the further advantage in particular in conjunction with a drive motor in the form of an internal combustion engine with turbocharging that a supercharging pressure of the exhaust turbocharger, and thus the output torque of the internal combustion engine, are increased by the rise in the rotational speed of the internal combustion engine. As a result, a high torque is available considerably earlier for an acceleration process of the motor vehicle compared to a shifting-down process without slip.

In order to implement the method according to the invention, there is no need for any additional components or changes to the clutch or to the automatic transmission. The possibility of being able to set a defined slip at the clutch is absolutely necessary for the operation of the drive train even without the use of the method according to the invention. The method can thus be implemented in a very cost-effective way and without taking up the installation space.

In one refinement of the invention, the increase in the slip at the clutch is dependent on operational variables of the motor vehicle. Operational variables are, for example, the velocity of the motor vehicle, the rotational speed and/or the output torque of the drive motor.

For example, various setpoint profiles for the slip at the clutch are stored in the control device. A setpoint profile is selected as a function of one or more of the aforesaid operational variables and the slip is set in accordance with the setpoint profile. Furthermore, it is possible to dispense completely with increasing the slip.

As a result, the design of the slip can be adapted to the current state of the motor vehicle.

In one refinement of the invention, the driver of the vehicle can set a predefined power value for the drive motor by means of the power actuator. For this purpose, the power actuator may, for example, be connected directly to a throttle valve of the drive motor. This direct coupling no longer exists in modern motor vehicles. In this case, a degree of activation of the power actuator is measured by a control device and a predefined power value for the drive motor is derived therefrom. The control device then actuates actuating elements of the drive motor in accordance with the predefined power value. The predefined power value may be, for example, in the form of a setpoint torque value in [Nm] or a setpoint power value in [kW].

The increase in the slip at the clutch takes place as a function of a characteristic value which characterizes the predefined power value. Characteristic values are, for example, the degree of activation of the power actuator, the torque or the power of the internal combustion engine when the shifting-down request is detected or the change in the aforesaid variables when the predefined power value is increased. Furthermore, a characteristic value may be derived from a derivative of the change of one of the aforesaid variables over time, such as from the rate of change of the degree of activation of the power actuator. A characteristic value can also be formed from a combination of a plurality of the abovementioned variables.

For example, a stored setpoint profile is selected as a function of one or more of the aforesaid characteristic variables and the slip is set in accordance with the setpoint profile. Furthermore, it is possible to dispense with the increase in the slip entirely.

As a result, the build up of the slip can be adapted to the current position or change in the predefined power value. For example, when there is a rapid change in the degree of activation of the power actuator a higher slip can be set than when there is a slow change. This also corresponds to the expectations of the driver of a vehicle. In addition to the level of the slip, it is also possible, for example, to change a profile of the slip as a function of a characteristic value. The reaction of the drive train thus corresponds particularly precisely to the preconceptions of the driver of the vehicle.

In one refinement of the invention, the slip at the clutch is increased as a function of a characteristic value which characterizes the driving style of the driver of the vehicle. With respect to driving style it is possible to distinguish, for example, between a steady driving style and a dynamic driving style. For example, an acceleration code, such as is described in DE 4401416 A1, can be used as a characteristic value. The characteristic value can be determined by the control device of the clutch and of the automatic transmission or by another control device of the motor vehicle on the basis of measured variables.

The increase in the slip and, therefore, also the reactions of the motor vehicle can thus be adapted to the driving style of the driver of the vehicle. For example, a higher slip can be set for a dynamic driving style, and a low slip, or even no slip at all, can be set for a steady driving style.

Further refinements of the invention emerge from the description and the drawing. Exemplary embodiments of the invention are illustrated in simplified form in the drawing and explained in more detail in the following description.

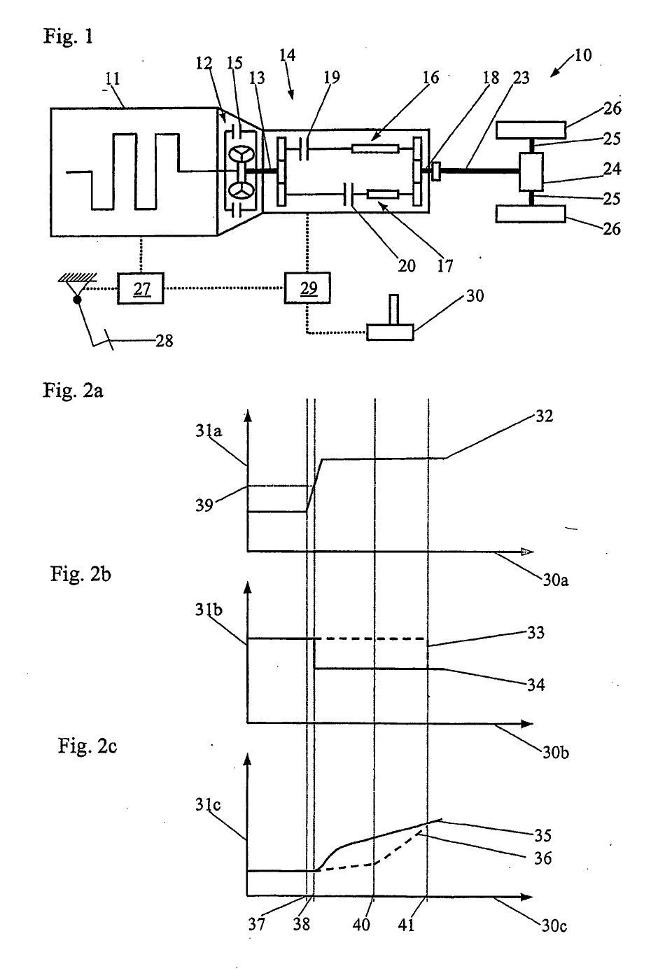

FIG. 1 is a basic diagram of a drive train of a motor vehicle, and

FIGS. 2a, 2b, 2c are diagrams representing the time profile of operational variables of the drive train when the automatic transmission shifts down.

### DETAILED DESCRIPTION OF THE DRAWINGS

According to FIG. 1, a drive train 10 of a motor vehicle (not illustrated) has a drive motor 11 which is embodied as an internal combustion engine. The internal combustion engine 11 is actuated by a control device 27. For this purpose, the control device 27 has a signal transmitting connection to actuating elements (not illustrated) of the drive motor 11 such as a throttle valve actuator, and sensors such as rotational speed sensors. Furthermore, the control device 27 has a signal transmitting connection to a power actuator 28 which is embodied as an accelerator pedal and by which a driver of a vehicle can set a predefined power value for the drive motor 11.

The drive motor 11 is connected by a hydraulic torque converter 12 to a transmission input shaft 13 of an automatic transmission 14. The torque converter 12 has a converter lock-up clutch 15 by which the transmission input shaft 13 can be connected directly to the drive motor 11. The converter lock-up clutch 15 can be actuated by a hydraulic actuator (not illustrated). The actuator is actuated by a control device 29 which can set a defined slip at the converter lock-up clutch 15.

The automatic transmission 14 is illustrated in a very schematic fashion and has a first gearspeed 16 and a second gearspeed 17 which are connected to a transmission output shaft 18. The transmission ratio of the first gearspeed 16 is shorter here than the transmission ratio of the second gearspeed 17. If the first gearspeed 16 is engaged, a multi-disk clutch 19 is closed, and if the second gearspeed 17 is engaged, a multi-disk clutch 20 is closed. A rotational speed and a torque are transmitted from the transmission output shaft 18 by a drive shaft 23 to an axle transmission 24 which, in a manner known per se, transmits the torque and the rotational speed to driven vehicle wheels 26 via two output shafts 25.

The transmission 14 is also actuated by the control device 29. As a result, the various gearspeeds 16 and 17 of the automatic transmission 14 can be engaged. For this purpose, the control device 29 has a signal transmitting connection to solenoid valves (not illustrated) by which the multi-disk clutches 19, 20 can have pressure applied to them to be closed and opened. When the engine is shifted down from the second gearspeed 17 into the first gearspeed 16, the multi-disk clutch 20 must be opened and the multi-disk clutch 19 must be closed. Before the multi-disk clutch 20 can be opened, the multi-disk clutch 19 must first be filled with gear oil so that a pressure can subsequently be built up and thus torque can be transmitted. If the multi-disk clutch 20 were already open before the multi-disk clutch 19 could transmit torque, the rotational speed of the drive motor 11 would increase in an uncontrolled fashion.

The control device 29 also has a signal transmitting connection to sensors (not illustrated) by which rotational speeds of the automatic transmission can be measured. The control device 29 has an additional transmitting connection to a selector lever 30 by which the driver of the vehicle can trigger shifting processes of the automatic transmission 14, and to the control device 27 of the internal combustion engine 11 in signal transmitting connection. From the control device 27, the control device 29 receives information about the state of the drive motor 11 such as a rotational speed or an output torque of the drive motor 11.

In FIGS. 2a, 2b and 2c, in each case the time is plotted on abscissas 30a, 30b and 30c, and a degree of activation of the power actuator 28 is plotted on an ordinate 31a, a gearspeed of the automatic transmission 14 is plotted on an ordinate 31b, and a rotational speed is plotted on an ordinate 31c.

In FIGS. 2a, 2b and 2c, the time profiles of the degree of activation of the power actuator 28 (line 32), of an actual gearspeed (dashed line 33), of a setpoint gearspeed (unbroken line 34), of the rotational speed (unbroken line 35) of the drive motor 11 and of the rotational speed (dashed line 36) of the transmission input shaft 13 are illustrated for a shifting-down process of the automatic transmission 14 which is triggered by an increase in the degree of activation of the power actuator 28.

Up to a time 37, the driver of the vehicle sets a constant degree of activation of the power actuator 28. The second gearspeed 17 of the automatic transmission 14 is engaged so that the setpoint gearspeed and the actual gearspeed correspond to the second gearspeed. The converter lock-up clutch 15 is closed so that no slip occurs at the converter lock-up clutch 15. As a result, a constant rotational speed of the drive motor 11 and an equally high rotational speed of the transmission input shaft 13 are brought about.

At the time 37, the driver of the vehicle very quickly increases the degree of activation of the power actuator 28 and thus exceeds, at the time 38, a degree 39 of activation at which a shifting-down request is triggered by the control device 29 at the current velocity of the motor vehicle (not illustrated). As a result of this, the target gearspeed jumps from the second gearspeed to the first gearspeed at the time 38.

Furthermore, the control device 29 starts to increase slip at the converter lock-up clutch 15 at the time 38. The profile of the slip is determined by the control device 29 as a function of operational variables of the motor vehicle. Owing to the increase in the slip at the converter lock-up clutch 15, the rotational speed of the drive motor 11 starts to increase at the time 38. The driver of the vehicle therefore receives feedback from the motor vehicle directly after the triggering of the shifting-down request and thus only shortly after the increase in the degree of activation of the power actuator 28.

When the shifting-down request is triggered at the time 38, the control device 29 begins to fill the multi-disk clutch 16. This filling phase is finished at the time 40. The filling phase may last between approximately 300 and 500 ms. The multi-disk clutch 20 cannot be opened until after the filling phase has ended, and the second gearspeed 17 is therefore engaged by then. As a result, the rotational speed of the transmission input shaft 13 cannot increase strongly until after the time 40. The increase in the rotational speed of the transmission input shaft 13 between the times 39 and 40 is due to a slight increase in the velocity of the motor vehicle. During the filling phase the slip is set in such a way that the rotational speed of the drive motor 11 is adjusted in a monotonously increasing fashion to the target rotational speed in the first gearspeed 16.

At the time 41, the multi-disk clutch 19 which is to be connected is completely closed so that the first gearspeed 16 is engaged and the rotational speed of the transmission input shaft 13 has reached the target rotational speed in the first gearspeed 16. As a result, the actual gearspeed also jumps from the second gearspeed to the first gearspeed at the time 41.

If no slip were set at the converter lock-up clutch 15 during the shifting-down process, the rotational speed of the drive motor 11 would also increase only after the filling phase has ended, that is to say only starting from the time 40. The reaction time of the motor vehicle would therefore be the time period from the times 37 to 40, instead of the time period from the times 37 to 38. The reaction time would therefore be 300 to 500 ms longer.

1.-5. (canceled)

6. A method for operating a drive train of a motor vehicle having
a drive motor,
a power-shift automatic transmission,
a clutch which is arranged between the drive motor and automatic transmission and is activated by extraneous force, and
at least one control device for actuating the automatic transmission and the clutch, the method comprising the steps:
using the control device to increase a slip at the clutch when a shifting-down request for the automatic transmission is detected,
using the control device to set a defined slip in such a way that by increasing the slip at the clutch a rotational speed of the drive motor is adjusted in a continuously increasing fashion to a target rotational speed after the shifting-down process has ended.

7. The method as claimed in claim 6, wherein the slip at the clutch is increased as a function of operational variables of the motor vehicle.

8. The method as claimed in claim 6, wherein the drive train has a power actuator whereby a driver of a vehicle sets a predefined power value for the drive motor, and the slip at the clutch is increased as a function of a characteristic value which characterizes the predefined power value.

9. The method as claimed in claim 7, wherein the drive train has a power actuator whereby a driver of a vehicle sets a predefined power value for the drive motor, and the slip at the clutch is increased as a function of a characteristic value which characterizes the predefined power value.

10. The method as claimed in claim 6, wherein the slip at the clutch is increased as a function of a characteristic value which characterizes the driving style of the driver of the vehicle.

11. The method as claimed in claim 6, wherein the control device sets the defined slip in such a way that the rotational speed of the drive motor reaches the target rotational speed before a rotational speed at the input of the automatic transmission.

12. The method as claimed in claim 7, wherein the control device sets the defined slip in such a way that the rotational speed of the drive motor reaches the target rotational speed before a rotational speed at the input of the automatic transmission.

13. The method as claimed in claim 8, wherein the control device sets the defined slip in such a way that the rotational speed of the drive motor reaches the target rotational speed before a rotational speed at the input of the automatic transmission.

14. The method as claimed in claim 9, wherein the control device sets the defined slip in such a way that the rotational speed of the drive motor reaches the target rotational speed before a rotational speed at the input of the automatic transmission.

15. The method as claimed in claim 10, wherein the control device sets the defined slip in such a way that the rotational speed of the drive motor reaches the target rotational speed before a rotational speed at the input of the automatic transmission.
